(19) United States
(12) Patent Application Publication
(10) Pub. No.: US 2019/0385249 A1
(43) Pub. Date: Dec. 19, 2019

(54) CLOUD BASED INDIAN SPEED SCRATCH COOKING SYSTEM

(71) Applicant: Bombay Rendezvous LLC DBA: Dama Indian Foodservice Solutions, Hayward, CA (US)

(72) Inventors: Irfan Dama, Oakland, CA (US); Nathan Downs, Hayward, CA (US)

(21) Appl. No.: 16/007,429

(22) Filed: Jun. 13, 2018

(51) Int. Cl. G06Q 50/12; A23L 23/00; G06Q 30/06

(52) U.S. Cl. CPC G06Q 50/12; A23V 2002/00; G06Q 30/0635; A23L 23/00

(57) ABSTRACT

Systems and methods are provided for preparing Indian cuisine. The method includes accessing a digital application on an electronic device, wherein the digital application is configured to enable the electronic device to connect to a remote server. The method further includes accessing, using the electronic device, a database of Indian cuisine products housed on the remote server, selecting one or more Indian cuisine products from the database to order, ordering the one or more Indian cuisine products, and freshly preparing the ordered one or more Indian cuisine products.

### CLAIM OF PRIORITY

This application is a United States non-provisional application and claims no priority to any previous United States patent application.

### FIELD OF THE EMBODIMENTS

This invention relates to food preparation and, in particular, to systems, methods, and delivery for efficient preparation of authentic Indian cuisine in residential and foodservice settings.

### BACKGROUND OF THE EMBODIMENTS

Indian professionals are flocking to the United States and they require authentic Indian cuisine in their home and at their workplace. The 2010 US Census listed Indians as one of the fastest growing ethnic groups with a 69% increase since 2000. In India, there are places in which you can give someone a meal in exchange for an entire day's work. As a result, the cuisine has evolved with very complex and time-consuming formulations.

Staying true to traditional Indian scratch cooking methods are cost prohibitive for foodservice operators with American labor and time prohibitive for working professionals to prepare at home. The current options of using aged spice blends, stabilized sauces and pastes delivers inferior results with undesirable additives. Inherently, corners are cut and authenticity is compromised when Indian scratch cooking is attempted in these environments.

The two most complex, and time-consuming, components of authentic Indian food are preparing the spice blends and base of stewed vegetables. Traditionally spices should be around fresh, blended, and toasted for each recipe and then a base of spices and vegetables will be manipulated for approximately 90 minutes. These steps reflect a significant amount of the skill and at least half of the time required to produce well developed authentic flavors.

A speed scratch system utilizing freshly prepared components is thus needed to meet the rising demand for authentic Indian flavors at home for working professionals and in the workplace for foodservice operators.

Examples of related art are described below:

U.S. Pat. No. 6,863,908 generally describes a universal sauce base, i.e. an edible composition, hiving a low pH for use in hot or cold food applications that is microbiologically stable, heat stable and freeze-thaw tolerant. The universal sauce base has an oil-in-water emulsion and comprises water, vegetable oil, starch, phospholipase A2 modified egg yolk and inorganic acid acidulent including at least phosphoric acid and other ingredients. The universal sauce base has a bland and non-sour flavor, can be used in a wide variety of food applications and can be combined with a wide range of flavors and other ingredients.

U.S. Pat. No. 9,031,867 generally describes a computer implemented method and system for ordering food that creates a cloud-based central account. The method uses computer instructions to create and store a user account and restaurant accounts in the central account. A dynamic library of restaurant information is connected to the user account, the restaurant account and the central account. A menu ordering software application is accessed by a client device processor. Computer instructions create an order and a code indicating the order price and menu items, prompt the restaurant to create the menu items in the order, and tell the client device processor when the order is ready for pick up.

U.S. Pat. No. 9,144,251 generally describes functional sweetener compositions comprising non-caloric or low-caloric natural and/or synthetic high-potency sweeteners and methods for making and using them. In particular, the present invention relates to different functional sweetener compositions comprising at least one-caloric or low-caloric natural and/or synthetic high-potency sweetener, at least one sweet taste improving composition, and at least one functional ingredient, such as a mineral. The present invention also relates to functional sweetener compositions and methods that can improve the tastes of non-caloric or low-caloric high-potency sweeteners by imparting a more sugar-like taste or characteristic. In particular, the functional sweetener compositions and methods provide a more sugar-like temporal profile, including sweetness onset and sweetness linger, and/or a more sugar-like favor profile.

U.S. Pat. No. 9,318,108 generally describes an intelligent automated assistant system engages with the user in an integrated, conversational manner using natural language dialog, and invokes external services when appropriate to obtain information or perform various actions. The system can be implemented using any of a number of different platforms, such as the web, email, smartphone, and the like, or any combination thereof. In one embodiment, the system is based on sets of interrelated domains and tasks, and employs additional functionally powered by external services with which the system can interact.

U.S. Patent Publication No. 2010/0166920 generally describes a spice packet has multiple compartments with instructions printed on a front side, where each compartment has instructions associated with a sequential step to be performed using the contents of the related compartment. The back side of the packet includes a shopping list and culinary information which may be of interest in establishing the historical background of the dish which uses the spice packet. The amounts of the spices in each packet are selected according to the strength of each individual spice which forms the contents of a packet.

U.S. Patent Publication No. 2017/0280755 generally describes propionic grain-based compositions comprising lactic acid-producing bacteria.

U.S. Patent Publication No. 2017/0323640 generally describes systems and methods for obtaining content over the Internet, identifying text within the content (e.g., such as closed captioning or recipe text) or creating text from the content using such technologies as speech recognition, analyzing the text for actionable directions, and translating those actionable directions into instructions suitable for network-connected cooking appliances. Certain embodiments provide additional guidance to avoid or correct mistakes in the cooking process, and allow for the customization of recipes to address, e.g., dietary restrictions, culinary preferences, translation into a foreign language, etc.

None of the art described above addresses all of the issues that the present invention does.

### SUMMARY OF THE EMBODIMENTS

According to an aspect of the present invention, a method for preparing Indian cuisine is provided. The method includes accessing a digital application on an electronic device, wherein the digital application is configured to enable the electronic device to connect to a remote server. The method farther includes accessing, using the electronic device, a database of Indian cuisine products housed on the remote server, selecting one or more Indian cuisine products from the database to order, ordering the one or more Indian cuisine products, and freshly preparing, the ordered one or more Indian cuisine products.

It is an object of the present invention to provide the method for preparing Indian cuisine, wherein the method further includes delivering the freshly prepared one or more Indian cuisine products to one or more users.

It is an object of the present invention to provide the method for preparing Indian cuisine, wherein the method further includes requesting, using a graphical user interface on the electronic device, a menu of various dishes that can be prepared by a user.

It is an object of the present invention to provide the method for preparing Indian cuisine, wherein the method further includes preparing the menu of various dishes.

It is an object of the present invention to provide the method for preparing Indian cuisine, wherein the accessing the digital application further includes logging into the digital application.

It is an object of the present invention to provide the method for preparing Indian cuisine, wherein the selecting one or more Indian cuisine products further includes selecting a quantity of the one or more Indian cuisine products.

It is an object of the present invention to provide the method for preparing Indian cuisine, wherein the ordered one or more Indian cuisine products includes one or more products selected from the group consisting of but not limited to: an Indian mother sauce and/or spice blends.

It is an object of the present invention to provide the method for preparing Indian cuisine, wherein the user can utilize freshly prepared components in a speed scratch system.

It is an object of the present invention to provide the method for preparing Indian cuisine, wherein preparing the mother sauce includes preparing the mother sauce and its ingredients in temperatures in excess of 140 degrees Fahrenheit for a period of approximately 20 minutes to 2 hours.

It is an object of the present invention to provide the method for preparing Indian cuisine, wherein the mother sauce is configured to be used to prepare one or more Indian chicken dishes selected from the group consisting of, but not limited to: Butter Chicken; Chicken Tikka Masala; Saag Chicken; Kadhai Chicken; Chicken Moilee; Chicken Biryani; Chicken Vindaloo; Tamil Chicken; Chicken Cashew Karma; Chicken Dalcha; Chicken Kheema; Achari Chicken; Chicken Kofta Curry; Methi Murgh; Malvani Chicken; Chicken 65; Chili Chicken; Chicken Chetinaad; and Chicken Xacuti.

It is an object of the present invention to provide the method for preparing Indian cuisine, wherein the mother sauce is configured to be used to prepare one or more Indian shrimp and/or fish dishes selected from the group consisting of, but not limited to: Shrimp Moilee; Tamil Shrimp; Shrimp Vindaloo; Shrimp Malaykari; Shrimp Biryani; Goa Fish Curry; Malvani Fish Curry; Prawns Chetinaad; Madras Fish Curry; Bombay Shrimp Chili Fry; and Doi Maach.

It is an object of the present invention to provide the method for preparing Indian cuisine, wherein the mother sauce is configured to be used to prepare one or more Indian lamb dishes selected from the group consisting of but not limited to: Lamb Tikka Masala; Lamb Saag; Lamb Biryani; Lamb Vindaloo; Tamil Lamb Curry; Lamb Cashew Korma; Lamb Dalcha; Shalgam Lamb; Lamb Kheema; Achari Lamb; Lamb Kofta Curry; Methi Lamb; Malvani Lamb; Lamb Chetinaad; Lamb Dahi Tamatar; and Lamb Xacuti.

It is an object of the present invention to provide the method for preparing Indian cuisine, wherein the mother sauce is configured to be used to prepare one or more Indian paneer or vegetable dishes selected from the group consisting of but not limited to: Paneer Makhani; Paneer Tikka Masala; Saag Paneer; Muttar Paneer; Paneer and Vegetables Biryani; Tamil Paneer and Vegetables, Paneer and Vegetables Cashew Korma; Paneer Moilee; Paneer and Vegetable Mircha, Achari Paneer; Paneer Kofta Curry, and Aloo Gobi.

According to another aspect of the present invention, a system for preparing Indian cuisine is provided. The system includes an electronic device, wherein the electronic device is configured to enable a user to access a digital application on an electronic device, and wherein the digital application is configured to enable the electronic device to connect to a remote server. The system further includes the remote server, wherein the remote server includes a processor and a memory, the me wry housing a database of Indian cuisine products housed, wherein the electronic device is configured to enable the user to access the database of Indian cuisine products, wherein the electronic device is configured to enable the user to select one or more Indian cuisine products from the database, and wherein the electronic device is configured to enable the user to order one or more Indian cuisine products from the database to be freshly prepared.

It is an object of the present invention to provide the system for preparing Indian cuisine, wherein the digital application is further configured to enable the user to request, using a graphical user interface on the electronic device, that a menu of various dishes can be prepared by the user.

It is an object of the present invention to provide the system for preparing Indian cuisine, wherein the electronic device is further configured to enable the user to select a quantity of the one or more Indian cuisine products.

It is an object of the present invention to provide the system for preparing Indian cuisine, wherein the digital application is further configured to automatically scale the one or more Indian cuisine products based on the quantities.

### BRIEF DESCRIPTION OF THE DRAWINGS

FIG. 1 shows a block-flow diagram of a system for preparing Indian cuisine, according to an embodiment of the present invention.

FIGS. 2-3 shows a method for preparing Indian cuisine, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The present invention relates to the fields of chemistry and food in an Indian cooking system that displaces the need for the extensive training and time required to produce authentic Indian food. According to an embodiment, the present system includes one “mother sauce” and three spice blends that are cornerstone to achieving authentic flavor profiles across 50+ of the most mainstream Indian dishes that are most common to the United States. According to an embodiment, the versatility of the mother sauce is achieved by sustaining the molecular transformation afforded by the Maillard reaction with temperatures in excess of 140 degrees Fahrenheit for a period of 20 minutes to 2 hours.

According to an embodiment, the mother sauce may include ingredients such as, e.g., onions, tomatoes, canola oil, garlic, ginger, jalapeno pepper, coriander powder, cumin powder, cayenne pepper powder, paprika powder, turmeric powder, garam masala powder, salt and/or any other suitable ingredients. According to an embodiment, the spice blends may include ingredients such as, e.g., salt, coriander powder, paprika powder, cayenne pepper powder, turmeric powder, onion powder, garlic powder, black pepper powder, ginger powder, dried cilantro, cardamom powder, clove powder, cinnamon powder, bay leaf powder, fennel powder, red chili flakes, and/or any other suitable ingredients.

Caramelization or caramelization (see spelling differences) is the oxidation of sugar, a process used extensively in cooking for the resulting nutty flavor and brown color. Caramelization is a type of non-enzymatic browning reaction. As the process occurs, volatile chemicals are released producing the characteristic caramel flavor. The reaction involves the removal of water (as steam) and the breakdown of the sugar. The caramelization reaction depends on the type of sugar. Sucrose and glucose caramelize around 160C (320F) and fructose. caramelizes at 110C (230F).

The highest rate of the color development is caused by fructose as caramelization of fructose starts at 110C. Baked goods made from honey or fructose syrup will therefore give a darker color. Caramelization of sucrose starts with the melting of the sugar at high temperatures followed by foaming (boiling). Sucrose first decomposes into glucose and fructose. This is followed by a condensation step, in which the individual sugars lose water and react with each other. Hundreds of new aromatic compounds are formed having a range of complex flavors.

In the case of the caramelization of sucrose three main product groups are formed: a dehydration product, caramelan C₁₂H₁₈O₉; and two polymers, carmelen C₃₆H₅₀O₂₅ and caramelin. The average molecular formula for caramelin C₁₂₅H₁₈₈O₈₀.

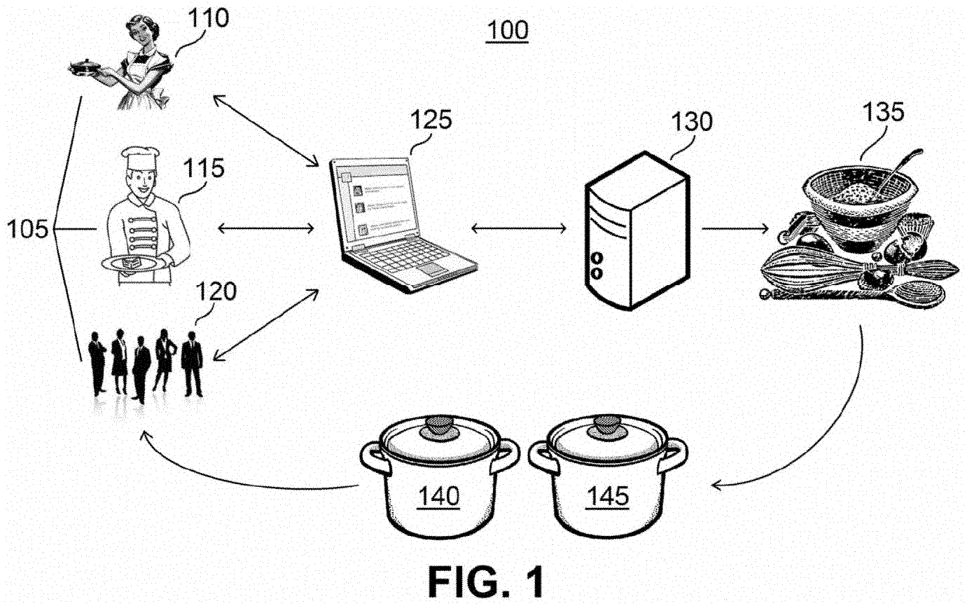

Referring now to FIG. 1, a block-flow diagram of a system 100 for preparing Indian cuisine is illustratively depicted, in accordance with an embodiment of the present invention.

According to an embodiment, the system 100 includes one or more users 105, one or more electronic devices 125 controlled by the users 105, a remote server 130, and a cooking station 135. According to an embodiment, the one or more user may be a home cook 110, a foodservice employee 115, one or more foodservice executives 120, and/or any other suitable users 105. According to an embodiment, the remote server 130 may include a processor and one or more memory storage sites.

According to an embodiment, the one or more users 105 access a digital application on the electronic device 125. According to an embodiment, the electronic device 125 may be a desktop computer, a laptop computer, a tablet computer, a smartphone, and/or any other suitable stationary or mobile electronic device. The electronic device 125 is coupled, via wired and/or wireless connection, to the remote server 130. According to an embodiment, the remote server 130 includes a memory that includes a database of various Indian dishes that one or more users 105 can view and from which the one or more users 105 can use to select the appropriate products used to create those dishes.

According to an embodiment, the one or more users 105 can order one or more products from the database using the digital application. Once the order is place, the food is freshly prepared 135 and sent back to the one or more users. According to an embodiment, the food may include a smother sauce 140 and/or one or more various spice blends 145.

According to an embodiment, the mother sauce 140 and spice blends 145 are freshly prepared and delivered. The result is a speed-scratch cooking system 100 that uses simple combinations of highly developed components.

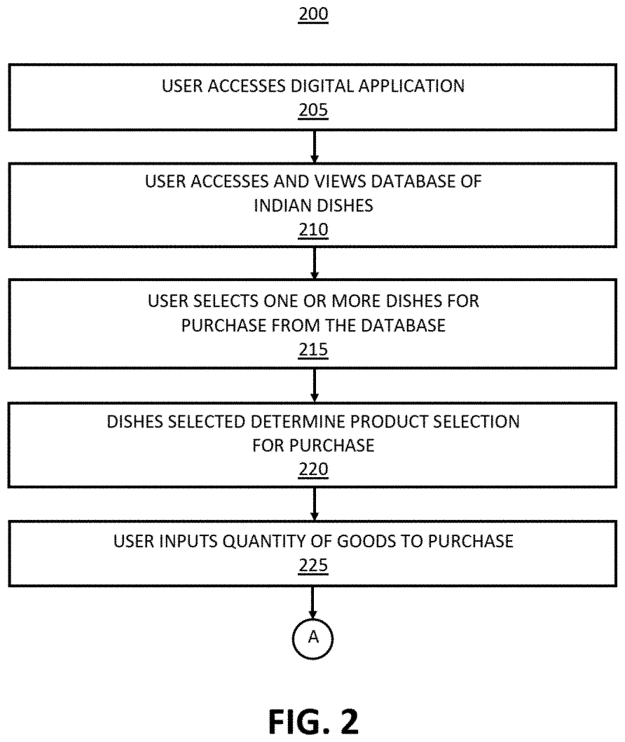

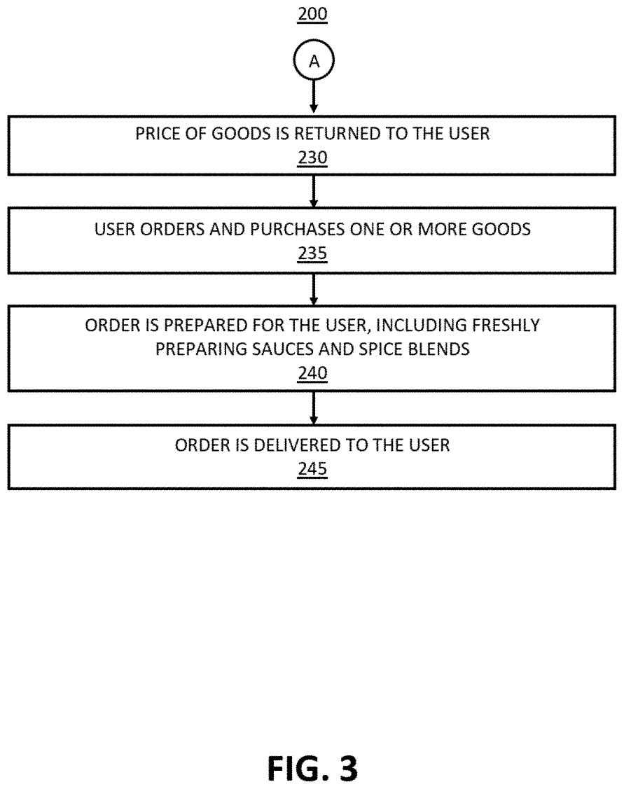

Referring now to FIGS. 2-3, a method 200 of preparing Indian cuisine is illustratively depicted, in accordance with an embodiment of the present invention.

At step 205, the one or more users 105, using the electronic device 125, accesses the digital application. According to an embodiment, the accessing may include logging into the application and/or inputting contact and/or billing information in order to process any orders made using the application.

Using the application, at step 210, the one or more users 105 are able to access and view a database housed on the remote server 130, the database listing various product listings available for purchase using the digital application. According to an embodiment, the database includes a plurality of Indian dishes. Using this database, the one or more users 105, at step 215, select one or more products for purchase from the database. According to an embodiment, the one or more users 105 select the one or more products for purchase using a graphical user interface coupled to the electronic device 125.

After selecting the one or more products, after the one or more users 105 selects one or more dishes for purchase, the application, at step 220, determines a product selection for purchase based on the selected dishes. According to an embodiment, at step 225, the one or more users 105 input a quantity of each product desired for purchase. According to an embodiment, the digital application automatically scales the product, according to the quantity, determining how much of each product is needed.

At step 230, the price for the goods selected is returned to one or more users 105 and, at step 235, the one or more users 105 purchases the goods. Once the goods are successfully ordered, the order, at step 240, is prepared for the one or more users 105, including freshly prepared sauces and/or spice blends.

According to an embodiment, preparing the order includes preparing a mother sauce 140 and/or one or more spice blends 145. These are the cornerstone to achieving authentic Indian flavor profiles across 50+ of the most mainstream Indian dishes that are most common to the United States. According to an embodiment, the versatility of the mother sauce is achieved by sustaining the molecular transformation afforded by the Maillard reaction with temperatures in excess of 140 degrees Fahrenheit for a period of 20 minutes to 2 hours.

Once the order is placed, the mother sauce 140 is produced. According to an embodiment, the mother sauce 140 is produced in a USDA facility to ensure food safety and consistency. The spice blends 145 are ground to order, then blended and packaged, and, at step 245, the sauce 140 and spice blends 145 are delivered to the one or more users 105.

According to various embodiments, the mother sauce 140 may be used to prepare chicken dishes such as, but not limited to, Butter Chicken, Chicken Tikka Masala, Saag Chicken, Kadhai Chicken, Chicken Moilee, Chicken Biryani, Chicken Vindaloo, Tamil Chicken, Chicken Cashew Korma, Chicken Dalcha, Chicken Kheema, Achari Chicken, Chicken Kofta Curry, Methi Murgh, Malvani Chicken, Chicken 65, Chili Chicken, Chicken Chetinaad, and Chicken Xacuti, among others.

According to various embodiments, the mother sauce 140 may be used to prepare shrimp and/or fish dishes such as, but not limited to, Shrimp Moilee, Tamil Shrimp, Shrimp Vindaloo, Shrimp Malaykari, Shrimp Biryani, Goa Fish Curry, Malvani Fish Curry, Prawns Chetinaad, Madras Fish Curry, Bombay Shrimp Chili Fry, and Doi Maach (Bengali Fish Curry), among others.

According to various embodiments, the mother sauce 140 may be used to prepare lamb dishes such as, but not limited to, Lamb Tikka Masala, Lamb Saag, Lamb Biryani, Lamb Vindaloo, Tamil Lamb Curry, Lamb Cashew Korma, Lamb Dalcha, Shalgam Lamb, Lamb Kheema, Achari Lamb, Lamb Kofta Curry, Methi Lamb, Malvani Lamb, Lamb Chetinaad, Lamb Dahi Tamatar, and Lamb Xacuti, among others.

According to various embodiments, the mother sauce 140 may be used to prepare paneer and/or vegetable dishes such as, but not limited to, Paneer Makhani, Paneer Tikka Masala, Saag Paneer, Muttar Paneer, Paneer & Vegetables Biryani, Tamil Paneer & Vegetables, Paneer & Vegetables Cashew Korma, Paneer Moilee, Paneer and Vegetable Mircha, Achari Paneer, Paneer Koila Curry, and Aloo Gobi, among others.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous charges in the details of construction and arrangement of parts may be resorted to without departing from the spirit and the scope of the invention.

What is claimed is:

1. A method for preparing Indian cuisine, comprising:
accessing a digital application on an electronic device,
wherein the digital application is configured to enable the electronic device to connect to a remote server;
accessing, using the electronic device, a database of Indian cuisine products housed on the remote server;
selecting one or more Indian cuisine products from the database to order;
ordering the one or more Indian cuisine products;
freshly preparing the ordered one or more Indian cuisine products.

2. The method as recited in claim 1, further comprising:
delivering the freshly prepared one or more Indian cuisine products to one or more users.

3. The method as recited in claim 1, further comprising:
requesting, using a graphical user interface on the electronic device, that a menu of various dishes be prepared for a user.

4. The method as recited in claim 3, further comprising:
selecting the menu of various dishes.

5. The method as recited in claim 1, wherein the accessing the digital application further includes logging into the digital application.

6. The method as recited in claim 1, wherein the selecting one or more Indian cuisine products further includes selecting a quantity of the one or more Indian cuisine products.

7. The method as recited in claim 1, wherein the ordered one or more Indian cuisine products includes one or re products selected from the group consisting of a mother sauce; and one or more spice blends.

8. The method as recited in claim 7, wherein freshly preparing the ordered one or more Indian cuisine products thither includes preparing the mother sauce.

9. The method as recited in claim 8, wherein preparing the mother sauce includes preparing the mother sauce and its ingredients in temperatures in excess of 140 degrees Fahrenheit for a period of approximately 20 minutes to 2 hours.

10. The method as recited in claim 7, wherein the mother sauce is configured to be used to prepare one or more Indian chicken dishes selected from the group consisting of Butter Chicken; Chicken Tikka Masala; Saag Chicken; Kadhai Chicken; Chicken Moilee; Chicken Biryani; Chicken Vindaloo; Tamil Chicken; Chicken Cashew Korma; Chicken Dalcha; Chicken Kheema; Achari Chicken; Chicken Kofta Curry Methi Murgh; Malvani Chicken; Chicken 65; Chili Chicken; Chicken Chetinaad; and Chicken Xacuti.

11. The method as recited in claim 7, wherein the mother sauce is configured to be used to prepare one or more Indian shrimp and/or fish dishes selected from the group consisting of: Shrimp Moilee; Tamil Shrimp; Shrimp Vindaloo; Shrimp Malaykari; Shrimp Biryani; Goa Fish Curry; Malvani Fish Curry; Prawns Chetinaad; Madras Fish Curry; Bombay Shrimp Chili Fry; and Doi Maach.

12. The method as recited in claim 7, wherein the mother sauce is configured to be used to prepare one or more Indian lamb dishes selected from the group consisting of: Lamb Tikka Masala; Lamb Saag; Lamb Biryani; Lamb Vindaloo; Tamil Lamb Curry; Lamb Cashew Korma; Lamb Dalcha; Shalgam Lamb; Lamb Kheema; Achari Lamb; Lamb Kofta Curry; Methi Lamb; Malvani Lamb; Lamb Chetinaad; Lamb Dahi Tamatar; and Lamb Xacuti.

13. The method as recited in claim 7, wherein the mother sauce is configured to be used to prepare one or more Indian paneer or vegetable dishes selected from the group consisting of: Paneer Makhani; Paneer Tikka Masala; Saag Paneer; Muttar Paneer; Paneer and Vegetables Biryani; Tamil Paneer and Vegetables; Paneer and Vegetables Cashew Korma; Paneer Moilee; Paneer and Vegetable Mircha; Achari Paneer; Paneer Kofta Curry; and Aloo Gobi.

14. A system for preparing Indian cuisine, comprising:
an electronic device,
wherein the electronic device is configured to enable a user to access a digital application on an electronic device,
wherein the digital application is configured to enable the electronic device to connect to a remote server; and
the remote server,
wherein the remote server includes a processor and a memory, the memory housing a database of Indian cuisine products housed,
wherein the electronic device is configured to enable the user to access the database of Indian cuisine products,
wherein the electronic device is configured to enable the user to select one or more Indian cuisine products from the database, and
wherein the electronic device is configured to enable the user to order one or more Indian cuisine products from the database to be freshly prepared.

15. The system as recited in claim 14, wherein the digital application is further configured to enable the user to request, using a graphical user interface on the electronic device, that a menu of various dishes be prepared by the user.

16. The system as recited in claim 14, wherein the electronic device is further configured to enable the user to select a quantity of the one or more Indian cuisine products.
